(19) United States
(12) Patent Application Publication
(10) Pub. No.: US 2020/0233285 A1
(43) Pub. Date: Jul. 23, 2020

(54) VIDEO MONITOR MOUNT

(71) Applicants: Geoff HANSEN, Edmonton (CA); Adele HANSEN, Edmonton (CA)

(72) Inventors: Geoff HANSEN, Edmonton (CA); Adele HANSEN, Edmonton (CA)

(21) Appl. No.: 16/750,110

(22) Filed: Jan. 23, 2020

(30) Foreign Application Priority Data
Jan. 23, 2019 (CA) 3 031 106

(51) Int. Cl. G03B 17/56; H02G 11/00; H02G 3/04; F16L 3/02; F16L 3/12

(52) U.S. Cl. CPC G03B 17/561; G03B 17/566; H02G 11/00; F16M 11/08; F16L 3/02; F16L 3/12; H02G 3/0481

(57) ABSTRACT

A baby monitor mount has a hollow tube that has a first end and a second end. The first end has a first opening and the second end has a second opening. The hollow tube is configured to house a power cord. A bracket box has a hollow interior and is pivotally attached to the first end of the hollow tube. The bracket box has a mounting plate that is configured such that it acts as a lid to the bracket box. The mounting plate is used for mounting a baby monitor. An aperture in bracket box is provided in communication with the first opening. The bracket box housing an electrical outlet in the hollow interior. A mounting apparatus is provided for mounting the hollow tube to a surface.

### FIELD OF THE DISCLOSURE

The present application relates generally to camera mounting system, more specifically it relates to a baby monitor crib and bed mount for use with video monitors.

### BACKGROUND

This section provides background information to facilitate a better understanding of the various aspects of the invention. It should be understood that the statements in this section of this document are to be read in this light, and not as admissions of prior art.

The wires used to power video monitoring systems for watching children while they sleep can pose a strangulation hazard. It is generally recommended that these wires be kept at least 3 feet away from where the child sleeps. This often results in having to place cameras in areas that provide poor views due to obstructions or placing the child's bed in an inconvenient location to ensure the wires are out of reach. Damage to walls and ceilings may also occur when mounting these cameras in an elevated position away from the crib. In each of these cases, the wire is still exposed in the child's play area.

Camera mounting systems that mount to walls have a number of disadvantages. When mounted, holes are created in walls and the effectiveness of the camera can be limited by the angle the camera is mounted. Generally, the power cord for these cameras hang loose and are a hazard to children. If furniture is moved or changed, it can be necessary to move the camera. With wall mounted cameras, any need to move the camera requires wall repairs because the mounts are invasive by nature.

Camera mounting systems that rely on stands generally rely on weights and legs to reduce the likelihood of tipping. As a result, they cannot be positioned near a crib or bed as a child could potentially grab the stand and knock it over. There is also the risk of electrocution or strangulation by the electrical cord.

### BRIEF SUMMARY

There is provided a baby monitor mount. The baby monitor mount has a hollow tube that has a first end and a second end. The first end has a first opening and the second end has a second opening. The hollow tube is configured to house a power cord. A bracket box having a hollow interior is pivotally attached to the first end of the hollow tube. The bracket box has a mounting plate configured such that it acts as a lid to the bracket box. An aperture in the bracket box is provided in communication with the first opening to allow the power cord to pass from the hollow tube to the hollow interior of the bracket box. A mounting apparatus is provided for mounting the hollow tube to a surface.

In one embodiment, the baby monitor mount has a holding bracket that is attached to the mounting plate to hold a baby monitor that has been mounted on the mounting plate. The holding bracket acts as a backup in the event that the baby monitor becomes unmounted from the mounting bracket and helps to prevent the baby monitor from accidently falling off of the mounting bracket.

In one embodiment, the mounting plate is detachable from the bracket box. This allows for different mounting plates to be used depending upon the mounting requirements of individual baby monitor systems.

In one embodiment, a tube sleeve is provided that encompasses the hollow tube. The tube sleeve is generally made of a soft material and encompasses the entire length of hollow tube.

In one embodiment, the mounting apparatus is a removable strap, a removable bracket, a compression clamp or an adhesive bracket.

In one embodiment, the hollow tube has at least two sections to allow for customization of length and shape. Straight sections and corner sections are commonly used to achieve a desired length and shape.

In one embodiment, the power cord passing through the hollow tube is hardwired into the electrical outlet in the hollow interior of the bracket box.

In one embodiment, the power cord that extends from the hollow tube is rigid. This helps to prevent accidental strangulation in the event that a child grabs a hold of it since it does not twist and cannot be twisted around the child's neck.

In one embodiment, the mounting plate is a universal mounting plate. The universal mounting plate may have a number of different attachment points to allow it to be used with any baby monitoring system.

In one embodiment, the hollow tube is collapsible to allow for easy transport and storage.

In one embodiment, the hollow tube is telescopic to allow for adjustments in length. Locking mechanisms such as friction locks may be used to maintain the length of hollow tube. When the hollow tube is made of sections, some sections may be telescopic while other sections may not be telescopic.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of a baby monitor mount.

FIG. 2 is a perspective view of the baby monitor mount mounted onto a crib.

FIG. 3 is an exploded view of the baby monitor mount.

FIG. 4 is a detailed perspective view of the bracket box and baby monitor.

FIG. 5 is an exploded view of the bracket box and baby monitor.

FIG. 6 is a perspective view, partially in section, of the bracket box with a mounted baby monitor.

FIG. 7 is a perspective view of the baby monitor mount mounted onto a crib using removable straps.

### DETAILED DESCRIPTION OF THE PREFERRED EMBODIMENTS

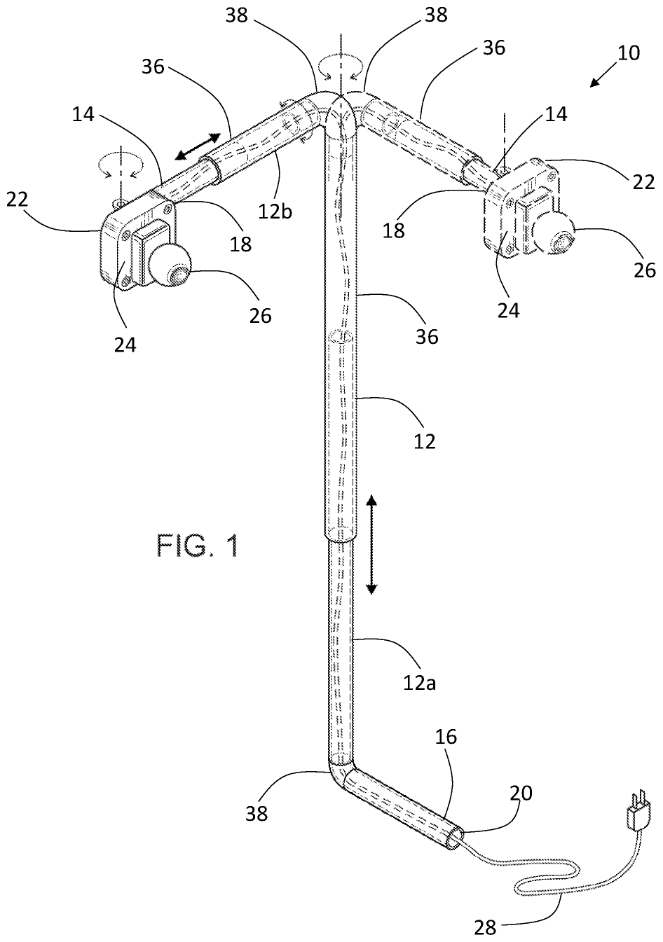

A baby monitor mount, generally identified by reference numeral 10, will now be described with reference to FIG. 1 through FIG. 7.

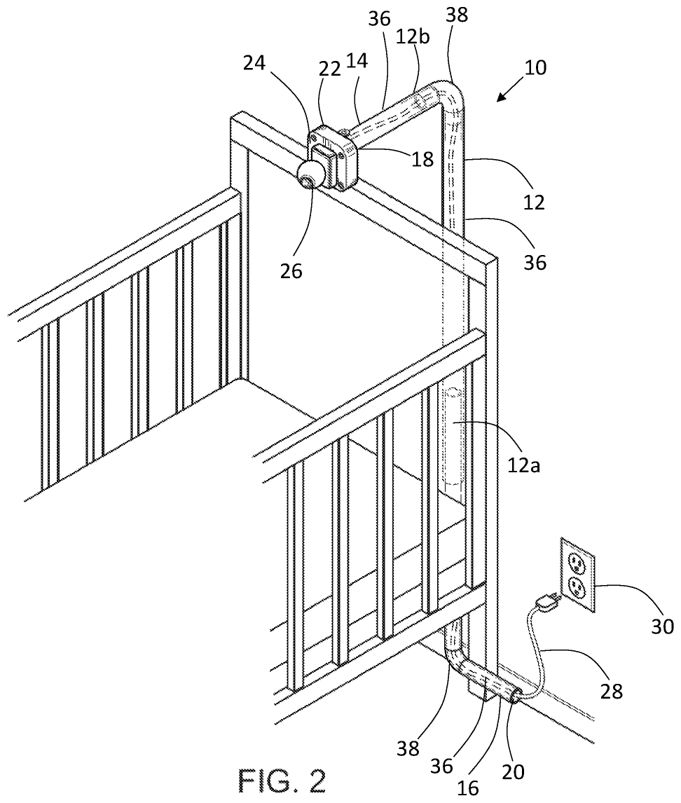

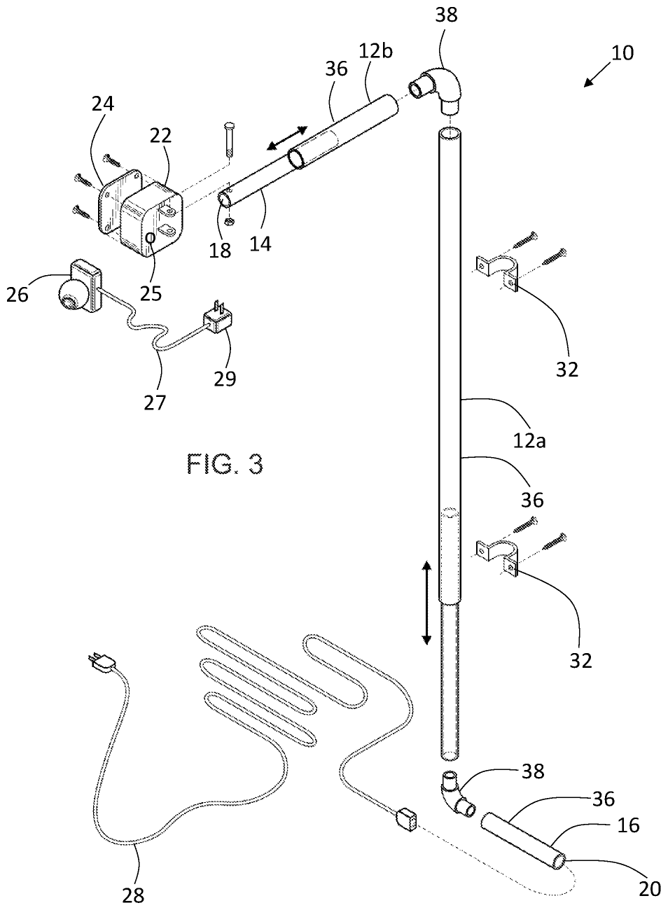

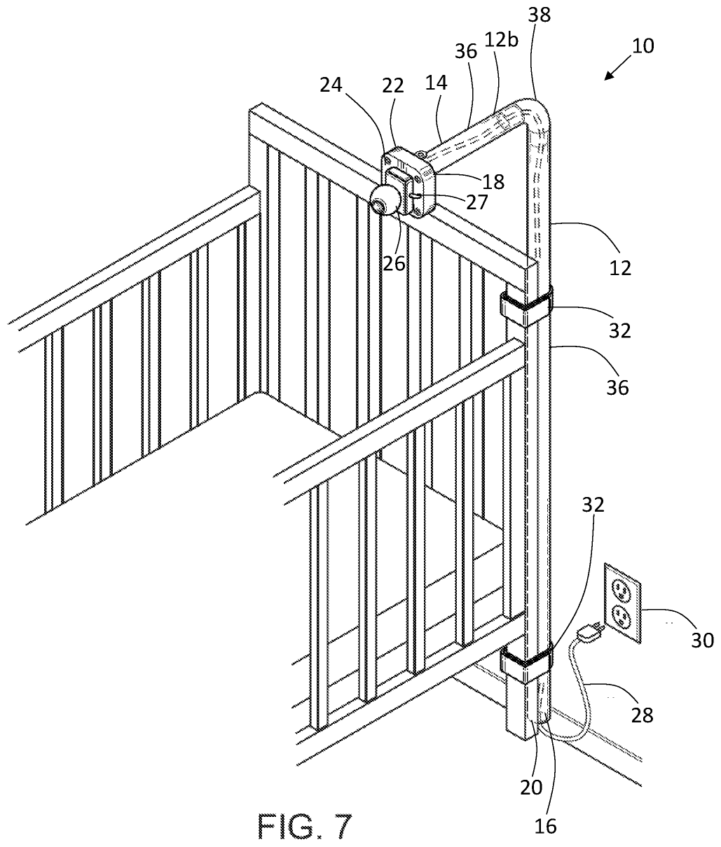

Referring to FIGS. 1 and 3, a baby monitor mount 10 has a hollow tube 12 that has a first end 14 and a second end 16. First end 14 has a first opening 18 and second end 16 has a second opening 20. Hollow tube 12 is preferably of a length and shape such that the baby monitor 26 is out of a child's reach. Referring to FIG. 2, hollow tube 12 encompasses electrical cord from a bracket box 22 to an electrical outlet 30 with electrical cord passing through second opening 20 to plug into electrical outlet 30. This reduces the risk of a child grabbing electrical cord or baby monitor. Hollow tube 12 is mounted onto a surface, such as a bed or crib, through the use of a mounting apparatus 32. Referring to FIG. 7, in the embodiment shown, mounting apparatus 32 is a removable strap. Referring to FIG. 3, in the embodiment shown, mounting apparatus 32 is a removable bracket. A compression clamp, an adhesive strap or any other suitable apparatus known to a person skilled in the art may also be used. The mounting apparatus 32 allows baby monitor mount to be attached to a variety of surfaces. When a video baby monitor is used, it allows the video baby monitor to be positioned in such a manner that an optimal viewing angle is possible.

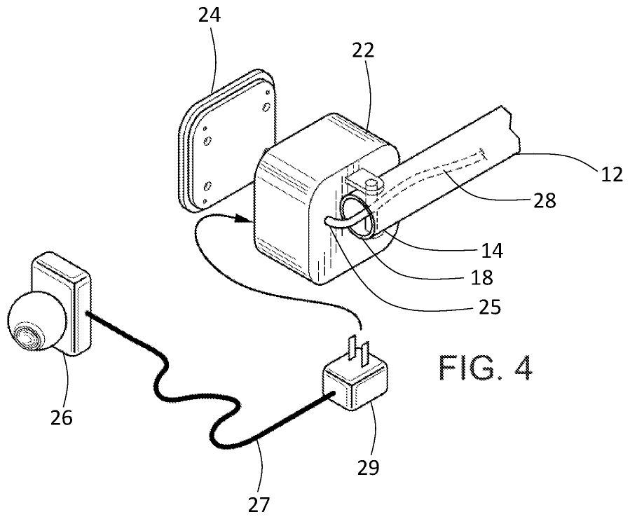

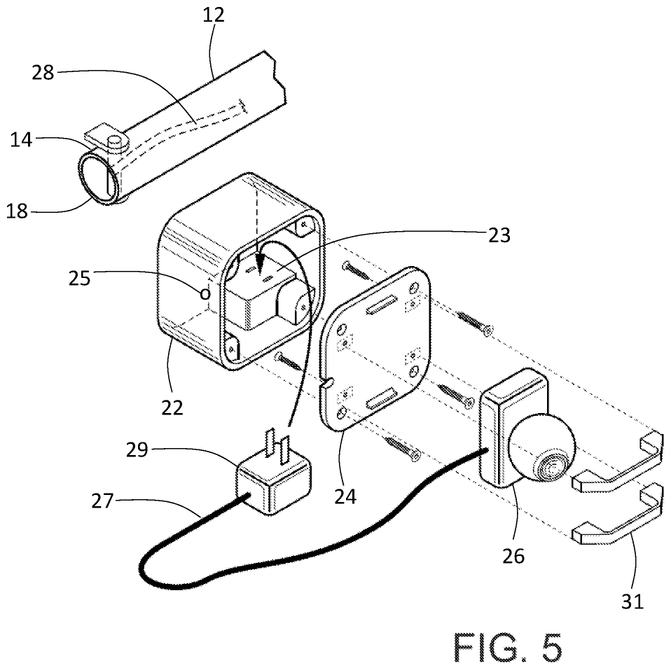

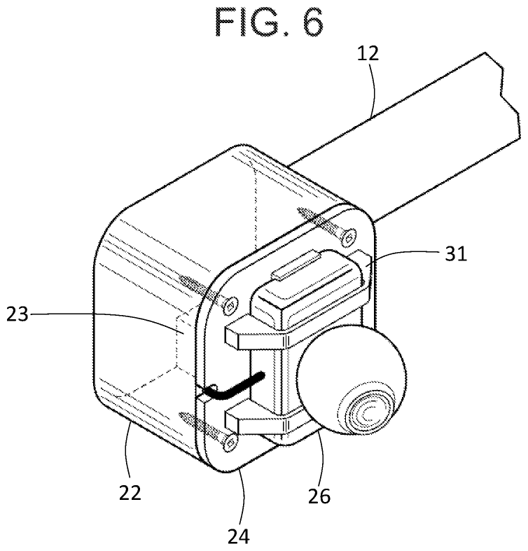

Referring to FIG. 4, bracket box 22 is pivotally attached to first end 14 of hollow tube 12. Referring to FIG. 5 and FIG. 6, bracket box 22 has a hollow interior. An aperture 25 in bracket box 22 allows electrical power to pass from hollow tube 12 into bracket box 22 where it may terminate at an electrical outlet 23 or be plugged in to the electrical outlet 23 to provide power to baby monitor 26. Bracket box 22 has a mounting plate 24 attached to it. Mounting plate 24 acts as a lid to bracket box 22 and is detachable to allow the power cord 27 attached to baby monitor 26 to be plugged into the electrical outlet in bracket box 22. When mounting plate 24 is attached to bracket box 22, the power cord 27 and plug 29 from the baby monitor 26 is enclosed within bracket box 22. This configuration helps to prevent a strangulation hazard that could exist if the power cord 27 was left hanging where a child could grab it. Multiple configurations of mounting plate 24 may be provided to create universality for mounting the selected baby monitor 26. The configuration of mounting plate 24 is dependent upon each individual baby monitor 26. Baby monitor 26 is mounted onto mounting plate 24. A person of skill will understand that the way in which baby monitor 26 is mounted to mounting plate 24 is dependent upon the type of baby monitor 26 used. Attached to mounting plate 24 is a security bracket 31 to hold the camera in place and ensure that it does not come loose from mounting plate 24. Referring to FIG. 5 and FIG. 6 the security bracket is a U shaped bracket. A zip tie, removable strap, adhesive strap, compression pin/latch or any other suitable apparatus known to a person skilled in the art may also be used.

Referring to FIG. 3, hollow tube 12 may be made up of one or more sections that allow hollow tube 12 to be lengthened, shortened or curved as needed to effectively encompass electrical cord from baby monitor 26 mounted on mounting plate 24 positioned on bracket box 22 at first end 14 of hollow tube 12 all the way to an electrical outlet 30 where the power cord 28 is plugged in. Hollow tube 12 may be collapsible to allow for easy transportation. Referring to FIG. 1, in the embodiment shown, straight sections 36 and corner sections 38 are used to create hollow tube 12. It becomes more difficult for a child to grab hold of the electrical cord when the entirety of the electrical cord is encompassed within hollow tube 12 and bracket box 22. This is beneficial as it reduces the chances of strangulation or electrocution that can occur when a child is able to reach an electrical cord. It is preferable for power cord 27 and 28 to be enclosed within hollow tube 12 or in a similar structure to a minimum distance for safety of the child. The distance is dependent upon the room, the child and furniture configurations, however 36 inches from the sleeping surface could be acceptable.

A tube sleeve 34 (not shown) may be provided that encompasses hollow tube 12. Tube sleeve 34 (not shown) is generally made of fabric and may improve the aesthetic qualities of hollow tube 12. A quilted or thick material may also serve the purpose of providing a cushioned surface to protect surfaces and the child in the event that a child makes contact with hollow tube 12.

For safety, it is preferable for power cord 28 to be hardwired into electrical outlet 23 in the interior of bracket box 22. Power cord 28 terminates in bracket box 22 at electrical outlet 23 into which baby monitor 26 can be plugged into. Power cord 28 extends out second opening 20 at second end 16 of hollow tube 12 to be plugged into a wall outlet. It is also preferred that the length of power cord 28 extending beyond second end 16 of hollow tube 12 be rigid to eliminate or limit the risk of strangulation.

In the embodiment shown in FIG. 3, hollow tube 12 is telescopic to allow for adjustments to the length of hollow tube 12. Locking mechanisms such as friction locks or other locks that would be challenging for a child to utilize may be used to maintain the length of hollow tube. When the hollow tube is made of sections, some sections may be telescopic while other sections may not be telescopic. In the embodiment shown, vertical section 12a of hollow tube 12 and horizontal section 12b of hollow tube 12 are both telescopic to allow for changes to the height and horizontal positioning of bracket box 22.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A baby monitor mount, comprising:
a hollow tube having a first end and a second end, the first end having a first opening and the second end having a second opening, the hollow tube being configured to house a power cord;
a bracket box having a hollow interior, the bracket box being pivotally attached to the first end of the hollow tube, the bracket box having a mounting plate being configured such that it acts as a lid to the bracket box, an aperture in the bracket box being in communication with the first opening, the bracket box housing an electrical outlet in the hollow interior; and
a mounting apparatus for mounting the hollow tube to a surface.

2. The baby monitor mount of claim 1 further comprising a holding bracket attached to the mounting plate to hold a baby monitor mounted on the mounting plate.

3. The baby monitor mount of claim 1 wherein the mounting plate is detachable.

4. The baby monitor mount of claim 1 wherein a tube sleeve encompasses the hollow tube.

5. The baby monitor mount of claim 1 wherein the mounting apparatus is a removable strap.

6. The baby monitor mount of claim 1 wherein the mounting apparatus is a removable bracket.

7. The baby monitor mount of claim 1 wherein the mounting apparatus is a compression clamp.

8. The baby monitor mount of claim 1 wherein the mounting apparatus is an adhesive strap.

9. The baby monitor mount of claim 1 wherein the hollow tube has at least two sections to allow for customization of length and shape.

10. The baby monitor mount of claim 1 wherein the power cord is hardwired into the electrical outlet in the hollow interior of the bracket box.

11. The baby monitor mount of claim 1 wherein the power cord extending from the hollow tube is rigid.

12. The baby monitor mount of claim 1 wherein the mounting plate is a universal mounting plate.

13. The baby monitor mount of claim 1 wherein the hollow tube is collapsible.

14. The baby monitor mount of claim 1 wherein the hollow tube is telescopic to allow for adjustments in length.
